(19) United States
(12) Patent Application Publication
(10) Pub. No.: US 2022/0103314 A1
(43) Pub. Date: Mar. 31, 2022

(54) METHOD EXECUTED BY USER EQUIPMENT, METHOD EXECUTED BY BASE STATION, USER EQUIPMENT, AND BASE STATION

(71) Applicant: NTT DOCOMO, INC., Tokyo (JP)

(72) Inventors: Runxin Wang, Beijing (CN); Wenjia Liu, Beijing (CN); Xiaolin Hou, Haidian District, Beijing (CN); Kazuaki Takeda, Tokyo (JP)

(73) Assignee: NTT DOCOMO, INC., Tokyo (JP)

(21) Appl. No.: 17/422,024

(22) PCT Filed: Jan. 11, 2019
(86) PCT No.: PCT/CN2019/071436

§ 371 Date: Jul. 9, 2021

(51) Int. Cl. H04L 5/00; H04W 72/04; H04L 1/16

(52) U.S. Cl. CPC H04L 5/0017; H04L 1/1621; H04W 72/0446

(57) ABSTRACT

Embodiments of the present invention provide a user equipment and a base station that may be used in a wireless communication system, or a method executed by a user equipment, a method executed by a base station. The user equipment in the embodiments of the present invention includes: an obtaining unit, configured to obtain a basic sequence table, the basic sequence table comprising at least two sequences; a receiving unit, configured to receive sequence selection information related to an operation to be executed by the user equipment; and a control unit, configured to determine an operation sequence for the operation according to the basic sequence table and the sequence selection information.

### TECHNICAL FIELD

The present disclosure relates to a field of wireless communication, and in particular to a user equipment and a base station that may be used in a wireless communication system, and methods performed by the user equipment and the base station.

### BACKGROUND

In a wireless communication system, for different transmission types or transmission scenarios, or as the number of user equipments (UEs) changes, different sequences may be selected for the same or different operations of a UE. For example, when the UE wants to add a multiple access signature to a symbol to be transmitted, it is necessary to preset a multiple access signature sequence table related to the addition of the multiple access signature and determine a corresponding multiple access signature sequence; and when the UE needs to transmit a demodulation reference signal (DMRS), it is necessary to preset a demodulation reference signal table related to the DMRS transmission and determine a corresponding demodulation reference signal. It can be seen that for various operations of a UE, different sequence tables need to be preset respectively for a base station to specify an operation-related sequence of the UE. However, this approach will greatly consume system overhead and occupy too much system resources.

Therefore, there is a need for a method for flexibly determining a related operation sequence for the operation of the UE, so as to reduce system overhead and improve the performance of the wireless communication system.

### SUMMARY OF THE DISCLOSURE

According to one aspect of the present disclosure, a user equipment is provided, comprising: an acquisition unit configured to acquire a basic sequence table, the basic sequence table includes at least two sequences; a receiving unit configured to receive sequence selection information related to an operation to be performed by the user equipment; a control unit configured to determine an operation sequence for the operation according to the basic sequence table and the sequence selection information.

According to an example of the present disclosure, wherein, the control unit determines a subset of the basic sequence table related to the operation according to the basic sequence table and the sequence selection information; determining the operation sequence for the operation from the subset of the basic sequence table.

According to an example of the present disclosure, wherein, the operation includes one or more of preamble transmission, multiple access signature addition, demodulation reference signal transmission and spreading.

According to an example of the present disclosure, wherein the sequence selection information comprises: one or more of a starting index for sequence selection, a number of groups for grouping the basic sequence table, a group index, a number of sequences in the subset of the basic sequence table and a spreading factor.

According to an example of the present disclosure, wherein, the receiving unit receives updated sequence selection information when the user equipment being reconfigured; the control unit determines an updated operation sequence according to the basic sequence table and the updated sequence selection information.

According to an example of the present disclosure, wherein, the receiving unit receives operation sequence occupation information transmitted by a base station; the control unit determines the operation sequence for the operation according to the operation sequence occupation information.

According to another aspect of the present disclosure, a base station is provided, comprising: a control unit configured to determine sequence selection information related to an operation to be performed by a user equipment; a transmitting unit configured to transmit the sequence selection information, so that the user equipment determines an operation sequence for the operation according to the basic sequence table and the sequence selection information.

According to an example of the present disclosure, wherein, the operation includes one or more of preamble transmission, multiple access signature addition, demodulation reference signal transmission and spreading.

According to an example of the present disclosure, wherein, the sequence selection information comprises: one or more of a starting index for sequence selection, a number of groups for grouping the basic sequence table, a group index, a number of sequences in the subset of the basic sequence table and a spreading factor.

According to an example of the present disclosure, wherein, the transmitting unit transmits updated sequence selection information when the user equipment being reconfigured, so that the user equipment determines an updated operation sequence according to the basic sequence table and the updated sequence selection information.

According to an example of the present disclosure, wherein, the base station further comprises an acquisition unit configured to acquire the operation sequence used by the user equipment for the operation; the transmitting unit transmits operation sequence occupation information according to the operation sequence, so that other user equipment determines its own operation sequence for the operation according to the operation sequence occupation information.

According to another aspect of the present disclosure, a method performed by a user equipment is provided, the method comprising: a method performed by a user equipment, the method comprising: acquiring a basic sequence table, the basic sequence table includes at least two sequences; receiving sequence selection information related to an operation to be performed by the user equipment; determining an operation sequence for the operation according to the basic sequence table and the sequence selection information.

According to an example of the present disclosure, wherein, the determining an operation sequence for the operation according to the basic sequence table and the sequence selection information comprises: determining a subset of the basic sequence table related to the operation according to the basic sequence table and the sequence selection information; determining the operation sequence for the operation from the subset of the basic sequence table.

According to an example of the present disclosure, wherein, the operation includes one or more of preamble transmission, multiple access signature addition, demodulation reference signal transmission and spreading.

According to an example of the present disclosure, wherein, the sequence selection information comprises: one or more of a starting index for sequence selection, a number of groups for grouping the basic sequence table, a group index, a number of sequences in the subset of the basic sequence table and a spreading factor.

According to an example of the present disclosure, wherein, the method further comprises: receiving updated sequence selection information when the user equipment being reconfigured; determining an updated operation sequence according to the basic sequence table and the updated sequence selection information.

According to an example of the present disclosure, wherein, the method further comprises: receiving operation sequence occupation information transmitted by a base station; determining the operation sequence for the operation according to the operation sequence occupation information.

According to another aspect of the present disclosure, a method performed by a base station is provided, the method comprising: determining sequence selection information related to an operation to be performed by a user equipment; transmitting the sequence selection information, so that the user equipment determines an operation sequence for the operation according to basic sequence table including at least two sequences and the sequence selection information.

According to an example of the present disclosure, wherein, the operation includes one or more of preamble transmission, multiple access signature addition, demodulation reference signal transmission and spreading.

According to an example of the present disclosure, wherein, the sequence selection information comprises: one or more of a starting index for sequence selection, a number of groups for grouping the basic sequence table, a group index, a number of sequences in the subset of the basic sequence table and a spreading factor.

According to an example of the present disclosure, wherein, the method further comprises: transmitting updated sequence selection information when the user equipment being reconfigured, so that the user equipment determines an updated operation sequence according to the basic sequence table and the updated sequence selection information.

According to an example of the present disclosure, wherein, the method further comprises: acquiring the operation sequence used by the user equipment for the operation; transmitting operation sequence occupation information according to the operation sequence, so that other user equipment determines its own operation sequence for the operation according to the operation sequence occupation information.

With the above aspects of the present disclosure, the subset of the basic sequence table related to the operation can be determined according to the basic sequence table and the sequence selection information indicated by the base station and related to the operation to be performed by the user equipment. Therefore, the operation sequence selection range related to the operation can be flexibly determined for the same or different operations of the user equipment, which improves the flexibility of sequence selection for the user equipment, reduces system overhead, and improves the performance of the wireless communication system.

### BRIEF DESCRIPTION OF THE DRAWINGS

The above and other objectives, features and advantages of the present disclosure will become more apparent by describing embodiments of the present disclosure in details in conjunction with accompanying drawings.

FIG. 1 shows a schematic diagram of a wireless communication system according to an embodiment of the present disclosure;

FIG. 2 shows a flowchart of a method performed by a user equipment according to an embodiment of the present disclosure;

FIG. 3 shows a schematic diagram of a basic sequence table according to an embodiment of the present disclosure;

FIG. 4 shows an example of subsets of the basic sequence table with a spreading factor of SF=4 in the basic sequence table;

FIG. 5 shows an example of subsets of the basic sequence table with a spreading factor of SF=2 in the basic sequence table;

FIG. 6 shows an example of subsets of the basic sequence table with spreading factors of SF=4 and SF=2 respectively in the basic sequence table;

FIG. 7 shows an example of information exchange between a UE, a base station and other UEs;

FIG. 8 shows another example of information exchange between a UE, a base station and other UEs;

FIG. 9 shows a flowchart of a method performed by a base station according to an embodiment of the present disclosure;

FIG. 10 shows a structural block diagram of a user equipment according to an embodiment of the present disclosure;

FIG. 11 shows a structural block diagram of a base station according to an embodiment of the present disclosure;

FIG. 12 is a diagram showing an example of a hardware structure of a user equipment and a base station according to an embodiment of the present disclosure.

### DESCRIPTION OF THE EMBODIMENTS

Methods performed by a user equipment and a base station, and the user equipment and the base station according to embodiments of the present disclosure will be described below with reference to the accompanying drawings. In the accompanying drawings, the same reference numerals represent the same components throughout. It should be understood that the embodiments described here are merely illustrative and should not be construed as limiting the scope of the present disclosure.

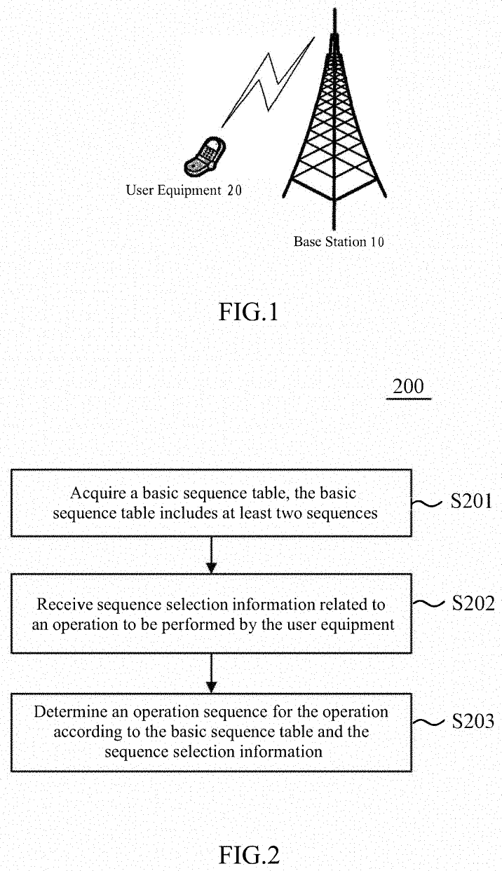

First, a wireless communication system according to an embodiment of the present disclosure will be described with reference to FIG. 1. As shown in FIG. 1, the wireless communication system may include a base station 10 and a user equipment (UE) 20. The UE 20 can communicate with the base station 10. It needs to be realized that although one base station and one UE are shown in FIG. 1, this is only illustrative, and the wireless communication system may include one or more base stations and one or more UEs.

In a wireless communication system, in different transmission types or transmission scenarios, it is necessary to determine corresponding operation sequences respectively for various operations of a UE. According to an example, during a random access procedure, the UE may determine a corresponding preamble sequence for preamble transmission. According to another example, the UE may utilize a multiple access signature (MA signature) sequence to add a multiple access signature to a symbol to be transmitted. According to another example, the UE may transmit a demodulation reference signal used for uplink channel demodulation. According to yet another example, the UE may use different spreading factors to spread symbols to be transmitted. In each of the foregoing examples, the UE needs to determine operation sequences corresponding to the operations respectively, and use the determined operation sequences to perform various operations.

Considering the foregoing application scenarios, it is desirable to provide a method for flexibly determining a related operation sequence for a UE operation, so as to reduce system overhead and improve the performance of the wireless communication system.

FIG. 2 shows a flowchart of a method 200 performed by a user equipment according to an embodiment of the present disclosure.

As shown in FIG. 2, in step S201, a basic sequence table is acquired, and the basic sequence table includes at least two sequences.

In an embodiment, the basic sequence table may be stored in advance on both the UE side and the base station side respectively. For example, the basic sequence table can be set in advance through related standards and stored on both the UE side and the base station side. In another embodiment, the basic sequence table may also be exchanged between a base station and a UE through signaling. For example, the base station may inform the UE of the basic sequence table currently used by transmitting setting information of the related basic sequence table or selection information of multiple basic sequence tables through higher level (such as MAC layer) signaling or DCI, etc.

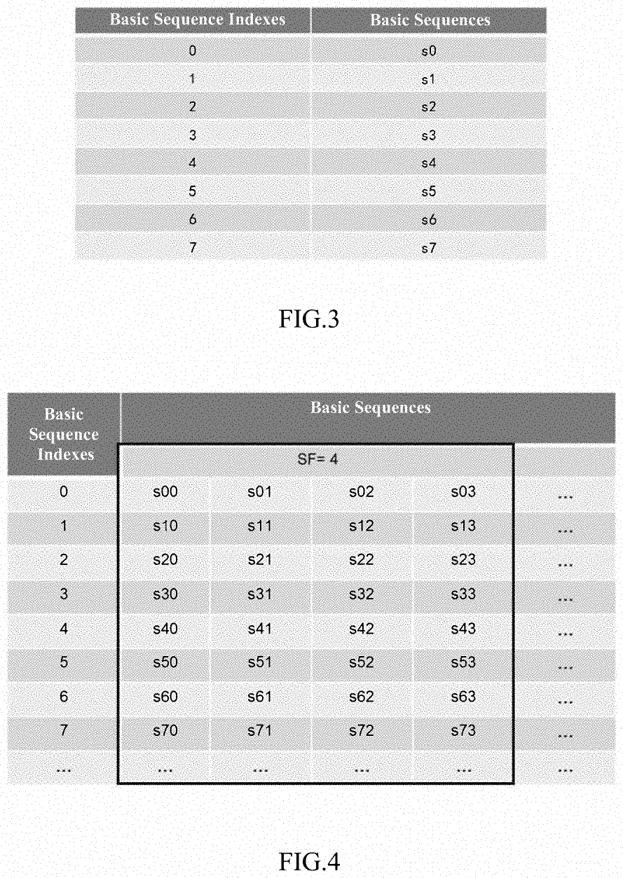

In one embodiment, the basic sequence table may respectively include basic sequence indexes and basic sequences corresponding to the basic sequence indexes. FIG. 3 shows a schematic diagram of a basic sequence table according to an embodiment of the present disclosure. As shown in FIG. 3, the basic sequence table may contain 8 basic sequences, which are s0-s8 respectively, with the basic sequence indexes of 0-7. The basic sequence table may be used by the UE to determine operation sequence(s) required for one or more types of operations. The representation of the basic sequence table, and the setting manner of one-to-one correspondence between the basic sequence indexes and the basic sequences in FIG. 3 are only examples. In practical applications, any setting manner of the basic sequence table can be used, and the number of the basic sequences contained therein is not limited.

In step S202, sequence selection information related to an operation to be performed by the user equipment is received.

In this step, the UE will receive the sequence selection information indicated by the base station, and the sequence selection information is related to the operation to be performed by the UE. The sequence selection information may cause the UE to select a subset of the basic sequence table related to the operation to be performed by the UE from the basic sequence table, and further determine an operation sequence for the operation therefrom. In one example, the base station may indicate the sequence selection information related to the operation to be performed by the UE through higher level signaling (such as Radio Resource Control (RRC) signaling); in another example, the base station may use, for example, Downlink Control Information (DCI) to indicate the sequence selection information related to the operation to be performed by the UE. In a specific implementation process, alternatively, the base station may indicate the type of the operation to be performed by the UE and the sequence selection information corresponding to the operation simultaneously, where the operation may be one or more. For example, the base station may indicate the type of the operation to be performed by the UE and the corresponding sequence selection information in an explicit manner (such as through one or more specific bits in the DCI); for another example, the base station may also indicate the type of the operation to be performed by the UE and the corresponding sequence selection information in an implicit manner (such as through specific positions in the DCI where the selection information is located), e.g., the first position in the DCI is used to indicate the operation type as MA signature addition and a corresponding MA sequence, and the second position in the DCI is used to indicate the operation type as DMRS transmission and a corresponding DMRS.

According to an embodiment of the present disclosure, the operation may include one or more of preamble transmission, multiple access signature addition, demodulation reference signal transmission, and spreading. According to another embodiment of the present disclosure, the sequence selection information may comprise: one or more of a starting index for sequence selection, the number of groups for grouping the basic sequence table, a group index, the number of sequences in the subset of the basic sequence table and a spreading factor.

In step S203, an operation sequence for the operation is determined according to the basic sequence table and the sequence selection information.

Where, first the subset of the basic sequence table related to the operation may be determined according to the basic sequence table and the sequence selection information; and then, the operation sequence for the operation is determined from the subset of the basic sequence table. The subset of the basic sequence table may be the basic sequence table itself or a part of the basic sequence table.

In an example, the UE may determine the subset of the basic sequence table related to the operation according to the basic sequence table, the number of the basic sequences M, the sequence selection information including a starting index for sequence selection i and the number of sequences in the subset of the basic sequence table m, and further determine an operation sequence in the subset. Since the UE has known the content of the basic sequence table, the value of the above-mentioned number of the basic sequences M can be directly obtained from the basic sequence table known by the UE. For example, when the operation is preamble transmission, a subset of the basic sequence table related to preamble transmission may be represented as: mod(i+j, M), where j=0, 1, . . . , m−1. Taking the basic sequence table shown in FIG. 3 as an example, when the number of the basic sequences M=8, the starting index for sequence selection i=6, and the number of sequences in the subset of the basic sequence table m=4, the subset of the basic sequence table for preamble sequence selection may be represented as {s6,s7,s0,s1}. The starting index for sequence selection i=6 in this example can also be understood as the index value, in the basic sequence table, of the starting sequence in the subset of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K and the number of sequences in the subset of the basic sequence table m, and further determine an operation sequence in the subset. Likewise, the value of the above-mentioned number of the basic sequences M can be directly obtained from the basic sequence table known by the UE. Alternatively, the manner of grouping the basic sequence table may be a preset grouping manner, or the UE may be informed of a specific grouping manner by the base station, which is not limited here. In an example, when the operation is multiple access signature, a subset of the basic sequence table related to multiple access signature may be represented as: mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, and the number of sequences in the subset of the basic sequence table m=4, a subset of the basic sequence table for the selection of a multiple access signature sequence may be represented as {s2,s3,s0,s1}. The starting index for sequence selection i=6 in this example can also be understood as the starting value for calculating the subset of the basic sequence table. In this example, the subset of the basic sequence table can be obtained from one or more groups of the basic sequence table; of course, the subset of the basic sequence table can also be exactly the same as the one or more groups of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K, a group index L and the number of sequences in the subset of the basic sequence table m, and further determine an operation sequence in the subset. Same as the foregoing, the value of the above-mentioned number of the basic sequences M can be directly obtained from the basic sequence table known by the UE. The manner of grouping the basic sequence table may be a preset grouping manner, or the UE may be informed of a specific grouping manner by the base station, which is not limited here. For example, when the operation is demodulation reference signal transmission, a subset of the basic sequence table related to the demodulation reference signal transmission may be represented as: L×M/K+mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, the group index L=1, and the number of sequences in the subset of the basic sequence table m=4, the subset of the basic sequence table for demodulation reference signal transmission may be represented as {s6,s7,s4,s5}. Likewise, in this example, the subset of the basic sequence table can be obtained from one or more groups of the basic sequence table; of course, the subset of the basic sequence table can also be exactly the same as the one or more groups of the basic sequence table.

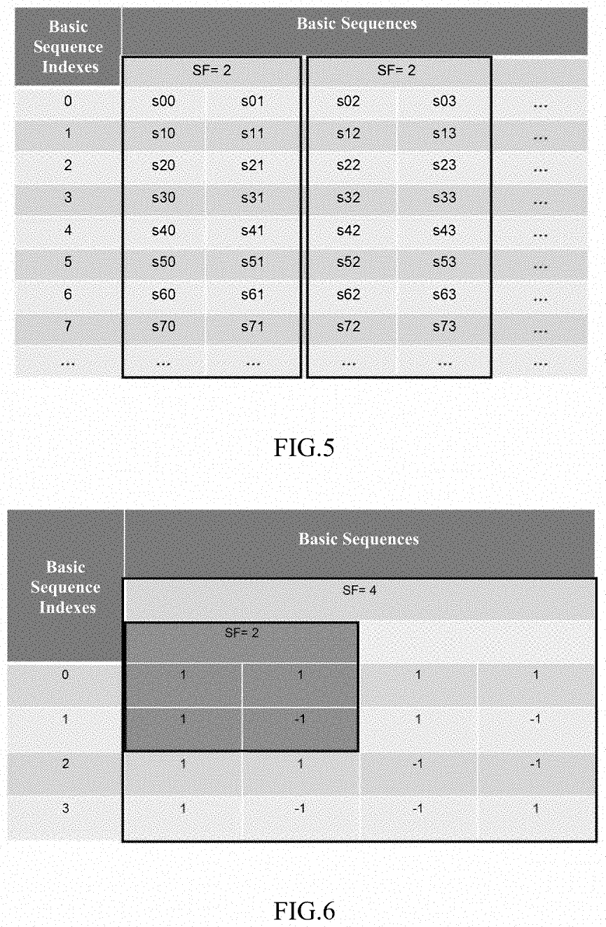

In another example, the UE may determine a subset of the basic sequence table related to spreading according to the basic sequence table and the sequence selection information including a spreading factor (SF), for indicating an spreading sequence used when spreading. FIG. 4 shows an example of subsets of the basic sequence table with a spreading factor of SF=4 in the basic sequence table. The table shown in FIG. 4 is the basic sequence table, and the part within the block is the subsets of the basic sequence table with the spreading factor of SF=4. For example, when the sequence selection information includes SF=4 and a starting index i=2, a subset of the basic sequence table may be represented as {s20,s21,s22,s23}. FIG. 5 shows an example of subsets of the basic sequence table with a spreading factor of SF=2 in the basic sequence table. The table shown in FIG. 5 is the basic sequence table, and the parts within the two blocks are the subsets of the basic sequence table with the spreading factor of SF=2 respectively. For example, when the sequence selection information includes SF=2 and a starting index i=5, a subset of the basic sequence table may be expressed as {s50, s51}, or may be represented as {s52, s53}. According to FIG. 4 and FIG. 5, it can be seen that when the basic sequence table is the same, different subsets of the basic sequence table may be determined according to different manners in which different spreading factors are nested in the basic sequence table. In a specific implementation process, the length of a spreading sequence can also be changed according to different spreading factors. FIG. 6 shows an example of subsets of the basic sequence table with spreading factors of SF=4 and SF=2 respectively in the basic sequence table. As shown in FIG. 6, when the spreading factor is SF=4, a subset of the basic sequence table may be {1,−1,1,−1} when the basic sequence index i=1, for example. When the spreading factor is SF=2, a subset of the basic sequence table may be {1, −1} when the basic sequence index i=1, for example.

The foregoing describes various examples of determining a subset of the basic sequence table according to the basic sequence table and the sequence selection information in this step. In an embodiment of the present disclosure, when transmission type or transmission scenario changes, or when the number of UEs changes, the UE can be reconfigured, and the subset of the basic sequence table determined by the UE and its operation sequence may be updated. Specifically, when the user equipment being reconfigured, the UE may receive updated sequence selection information transmitted by the base station, and determine an updated operation sequence according to the basic sequence table and the updated sequence selection information. Alternatively, an updated subset of the basic sequence table may be determined first according to the basic sequence table and the updated sequence selection information, and then the updated operation sequence may be determined therefrom. In addition, the base station can also indicate the updated sequence selection information through higher level signaling (for example, Radio Resource Control (RRC) signaling) or through, for example, Downlink Control Information (DCI). The sequence selection information may still include: one or more of a starting index for sequence selection, the number of groups for grouping the basic sequence table, a group index, the number of sequences in the subset of the basic sequence table and a spreading factor. Alternatively, the updated sequence selection information may be an updated value of one or more of the aforementioned parameters. For example, the updated sequence selection information may update the starting index for sequence selection i to i+offset by adding an offset value “offset”, and/or update the number of sequences in the subset of the basic sequence table m to m+offset. For another example, the updated sequence selection information may also modify the number of groups for grouping the basic sequence table K or the group index L to K+1 or L+2 respectively. The above manners for updating the sequence selection information are only examples. In practical applications, any manner for updating the sequence selection information can be used, which is not limited here.

In one example, when the UE determines an operation sequence for an operation from the subset of the basic sequence table (or the updated subset of the basic sequence table), it may arbitrarily select one of the sequences, as the operation sequence for the operation, in the subset determined according to the basic sequence table and the sequence selection information. In another example, in order to avoid resource conflicts with other UEs, the UE may also first receive operation sequence occupancy information transmitted by the base station and related to resources (as represented by operation sequences) occupied by the other UEs, and determine the operation sequence for the operation according to the operation sequence occupancy information. Alternatively, the operation sequence occupation information may be included in the sequence selection information to be transmitted together, or may be transmitted separately. That is, the operation sequence occupation information may be a part of the sequence selection information, or may be independent of the sequence selection information. Where, the base station can obtain operation sequences used by the other UEs through its received uplink data transmitted by the other UEs through a certain operation, and obtain the corresponding operation sequence occupation information to inform the UE. For example, when the subset of the basic sequence table determined by the UE is {s2, s3, s0, s1}, and the operation sequence occupancy information of the other UEs includes {s2}, this can make the UE select the operation sequence for the operation in {s3, s0, s1}.

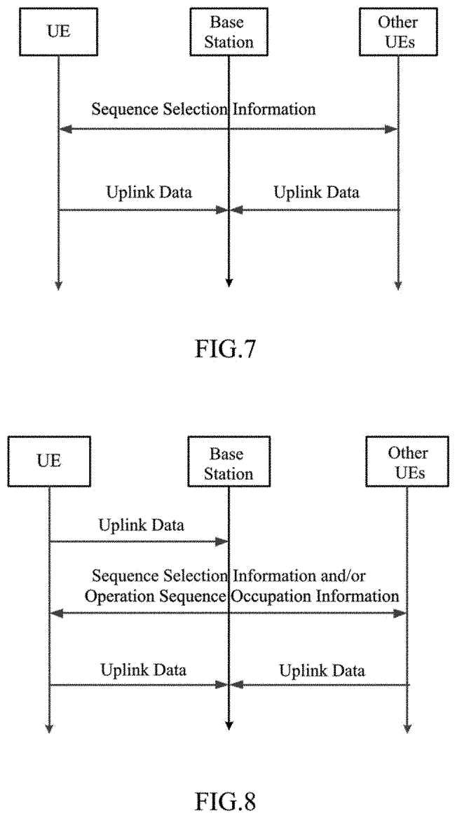

FIG. 7 shows an example of information exchange between a UE, a base station and other UEs. As shown in FIG. 7, the base station may simultaneously transmit sequence selection information used to indicate the involvement of a certain operation to the UE and the other UEs. After receiving the sequence selection information, the UE and the other UEs may determine a subset of the basic sequence table according to the basic sequence table and the sequence selection information respectively, and further determine a respective operation sequence for the operation. In this process, the base station may transmit the sequence selection information within a specific time range before the operation is performed, so as to ensure that each UE can obtain the sequence selection information before performing the operation and further determine a corresponding operation sequence. After determining their respective operation sequences, the UE and the other UEs will perform corresponding operations and transmit uplink data. The sequence selection information may be transmitted periodically or aperiodically. In an example, the base station may transmit the sequence selection information together with other configuration information (for example, Modulation and Coding Scheme (MCS)) to save the signaling resources of the system. In another example, the base station may transmit the sequence selection information in a common search space by using GC-PDCCH (Physical Downlink Control Channel) or other DCI, so that each UE is able to detect the sequence selection information and without the need to separately instruct each UE.

FIG. 8 shows another example of information exchange between a UE, a base station and other UEs. As shown in FIG. 8, one or more UEs may first use an operation sequence corresponding to a certain available resource to operate and transmit uplink data to the base station, and then the base station may obtain corresponding operation sequence occupation information of the one or more UEs through its received uplink data related to the operation, and transmit sequence selection information and/or the operation sequence occupation information. After transmitting the operation sequence occupancy information, the base station can make other UEs avoid using the operation sequence which is already occupied to operate, thereby avoiding resource conflicts under Non-Orthogonal Multiple Access (NOMA), for example. Where, the operation sequence occupation information may be included in the sequence selection information for transmission, or may be transmitted separately. In this process, the base station may also transmit the sequence selection information and/or the operation sequence occupancy information within a specific time range before the operation is performed, so as to ensure that each UE can obtain required information before performing the operation and further determine a corresponding operation sequence. After determining their respective operation sequences, the UE and the other UEs will transmit uplink data respectively. The sequence selection information and/or operation sequence occupation information may be transmitted periodically or aperiodically. In an example, the base station may transmit the sequence selection information and/or the operation sequence occupation information together with other configuration information (for example, Modulation and Coding Scheme (MCS)) to save the signaling resources of the system. In another example, the base station may transmit the sequence selection information and/or the operation sequence occupation information in a common search space by using GC-PDCCH (Physical Downlink Control Channel) or other DCI, so that each UE is able to detect the sequence selection information and without the need to separately instruct each UE.

When the base station transmits the sequence selection information and/or the operation sequence occupation information through DCI, the transmission may be performed through an existing DCI format, or may be performed through a new DCI format. For example, the base station can use one or more existing DCIs for transmission: using DCI format 2_0, DCI format 2_1, DCI format 2_2, DCI format 2_3 in GC-PCDDH for transmission; using different Radio Network Tempory Identity (RNTI) scrambling manners in a common search space (DCI 0_0, DCI 0_1) for transmission, using reserved bits (for example, indexes 29-31 of table 1/3 in MCS, indexes 28-31 of other MCS tables) for transmission, or using a “uplink Sounding Reference Signal (SRS) resource indicator” field, a “precoding information and number of layers” field, a “antenna port” field and so on for transmission. For another example, the base station can also use a new 4-9 bits DCI format for transmission. In the foregoing various DCI transmission manners, the base station can use various value ranges to respectively indicate parameters such as the starting index of the demodulation reference signal and the number of groups, or the starting index of the multiple access signature sequence and the number of groups. For example, the starting index of the demodulation reference signal can be defined as 0-15, and the number of groups can be defined as 0-3; or the starting index of the multiple access signature sequence can be defined as 0-31, and the number of groups can be defined as 0-7. The above definition of the DCI formats and the value ranges of the related parameters is only an example. In practical applications, any DCI format and value manner can be used, and there is no limitation here.

With the above methods of the present disclosure, a subset of a basic sequence table related to an operation to be performed by a user equipment can be determined according to the basic sequence table and sequence selection information indicated by the base station and related to the operation. Therefore, there is no need to separately set a sequence table for each type of operation, and an operation sequence can be flexibly determined for the same or different operations of the user equipment, which improves the flexibility of sequence selection of the user equipment, reduces system overhead, and improves the performance of the wireless communication system. In addition, by restricting the subset of the basic sequence table corresponding to various operations of the user equipment, it is also possible to avoid resource conflicts under NOMA as much as possible, improving the effectiveness of information transmission.

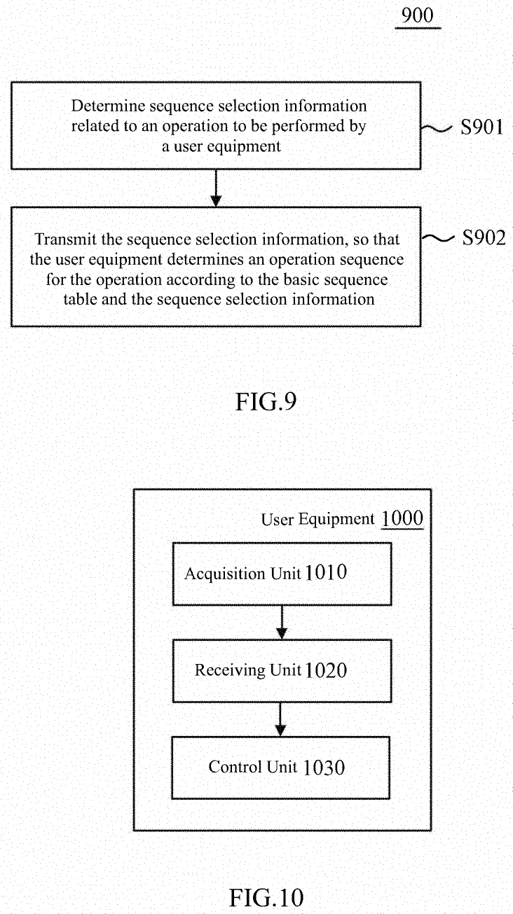

FIG. 9 shows a flowchart of a method 900 performed by a base station according to an embodiment of the present disclosure.

As shown in FIG. 9, in step S901, sequence selection information related to an operation to be performed by a user equipment is determined.

The sequence selection information is used by a UE to determine an operation sequence for the operation from a basic sequence table. Specifically, the UE may first determine a subset of the basic sequence table related to the operation according to the basic sequence table and the sequence selection information; and then, the UE may determine the operation sequence for the operation from the subset of the basic sequence table.

In an embodiment, the basic sequence table may be stored in advance on both the UE side and the base station side respectively. For example, the basic sequence table can be set in advance through related standards and stored on both the UE side and the base station side. In another embodiment, the basic sequence table may also be exchanged between a base station and a UE through signaling. For example, the base station may inform the UE of the basic sequence table currently used by transmitting setting information of the related basic sequence table or selection information of multiple basic sequence tables through higher level (such as MAC layer) signaling or DCI, etc.

In one embodiment, the basic sequence table may respectively include basic sequence indexes and basic sequences corresponding to the basic sequence indexes. FIG. 3 shows a schematic diagram of a basic sequence table according to an embodiment of the present disclosure. As shown in FIG. 3, the basic sequence table may contain 8 basic sequences, which are s0-s8 respectively, with the basic sequence indexes of 0-7. The basic sequence table may be used by the UE to determine operation sequence(s) required for one or more types of operations. The representation of the basic sequence table, and the setting manner of one-to-one correspondence between the basic sequence indexes and the basic sequences in FIG. 3 are only examples. In practical applications, any setting manner of the basic sequence table can be used, and the number of the basic sequences contained therein is not limited.

According to an embodiment of the present disclosure, the operation to be performed by the user equipment may include one or more of preamble transmission, multiple access signature addition, demodulation reference signal transmission, and spreading. According to another embodiment of the present disclosure, the sequence selection information may comprise: one or more of a starting index for sequence selection, the number of groups for grouping the basic sequence table, a group index, the number of sequences in the subset of the basic sequence table and a spreading factor.

In step S902, the sequence selection information is transmitted, so that the user equipment determines an operation sequence for the operation according to the basic sequence table including at least two sequences and the sequence selection information.

In one example, the base station may indicate the sequence selection information related to the operation to be performed by the UE through higher level signaling (such as Radio Resource Control (RRC) signaling); in another example, the base station may use, for example, Downlink Control Information (DCI) to indicate the sequence selection information related to the operation to be performed by the UE. In a specific implementation process, alternatively, the base station may indicate the type of the operation to be performed by the UE and the sequence selection information corresponding to the operation simultaneously, where the operation may be one or more. For example, the base station may indicate the type of the operation to be performed by the UE and the corresponding sequence selection information in an explicit manner (such as through one or more specific bits in the DCI); for another example, the base station may also indicate the type of the operation to be performed by the UE and the corresponding sequence selection information in an implicit manner (such as through specific positions in the DCI where the selection information is located), e.g., the first position in the DCI is used to indicate the operation type as MA signature addition and a corresponding MA sequence, and the second position in the DCI is used to indicate the operation type as DMRS transmission and a corresponding DMRS.

After receiving the sequence selection information transmitted by the base station, as described in the above, the UE may first determine the subset of the basic sequence table related to the operation according to the basic sequence table and the sequence selection information; and then, the UE may determine the operation sequence for the operation from the subset of the basic sequence table. The subset of the basic sequence table may be the basic sequence table itself or a part of the basic sequence table.

In an example, the UE may determine the subset of the basic sequence table related to the operation according to the basic sequence table, the number of the basic sequences M, the sequence selection information including a starting index for sequence selection i and the number of sequences in the subset of the basic sequence table m, and further determine an operation sequence in the subset. Since the UE has known the content of the basic sequence table, the value of the above-mentioned number of the basic sequences M can be directly obtained from the basic sequence table known by the UE. For example, when the operation is preamble transmission, a subset of the basic sequence table related to preamble transmission may be represented as: mod(i+j, M), where j=0, 1, . . . , m−1. Taking the basic sequence table shown in FIG. 3 as an example, when the number of the basic sequences M=8, the starting index for sequence selection i=6, and the number of sequences in the subset of the basic sequence table m=4, the subset of the basic sequence table for preamble sequence selection may be represented as {s6,s7,s0,s1}. The starting index for sequence selection i=6 in this example can also be understood as the index value, in the basic sequence table, of the starting sequence in the subset of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K and the number of sequences in the subset of the basic sequence table m, and further determine an operation sequence in the subset. Likewise, the value of the above-mentioned number of the basic sequences M can be directly obtained from the basic sequence table known by the UE. Alternatively, the manner of grouping the basic sequence table may be a preset grouping manner, or the UE may be informed of a specific grouping manner by the base station, which is not limited here. In an example, when the operation is multiple access signature, a subset of the basic sequence table related to multiple access signature may be represented as: mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, and the number of sequences in the subset of the basic sequence table m=4, a subset of the basic sequence table for the selection of a multiple access signature sequence may be represented as {s2,s3,s0,s1}. The starting index for sequence selection i=6 in this example can also be understood as the starting value for calculating the subset of the basic sequence table. In this example, the subset of the basic sequence table can be obtained from one or more groups of the basic sequence table; of course, the subset of the basic sequence table can also be exactly the same as the one or more groups of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K, a group index L and the number of sequences in the subset of the basic sequence table m, and further determine an operation sequence in the subset. Same as the foregoing, the value of the above-mentioned number of the basic sequences M can be directly obtained from the basic sequence table known by the UE. The manner of grouping the basic sequence table may be a preset grouping manner, or the UE may be informed of a specific grouping manner by the base station, which is not limited here. For example, when the operation is demodulation reference signal transmission, a subset of the basic sequence table related to the demodulation reference signal transmission may be represented as: L×M/K+mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, the group index L=1, and the number of sequences in the subset of the basic sequence table m=4, the subset of the basic sequence table for the demodulation reference signal transmission may be represented as {s6,s7,s4,s5}. Likewise, in this example, the subset of the basic sequence table can be obtained from one or more groups of the basic sequence table; of course, the subset of the basic sequence table can also be exactly the same as the one or more groups of the basic sequence table.

In another example, the UE may determine a subset of the basic sequence table related to spreading according to the basic sequence table and the sequence selection information including a spreading factor (SF), for indicating an spreading sequence used when spreading. FIG. 4 shows an example of subsets of the basic sequence table with a spreading factor of SF=4 in the basic sequence table. The table shown in FIG. 4 is the basic sequence table, and the part within the block is the subsets of the basic sequence table with the spreading factor of SF=4. For example, when the sequence selection information includes SF=4 and a starting index i=2, a subset of the basic sequence table may be represented as {s20,s21,s22,s23}. FIG. 5 shows an example of subsets of the basic sequence table with a spreading factor of SF=2 in the basic sequence table. The table shown in FIG. 5 is the basic sequence table, and the parts within the two blocks are the subsets of the basic sequence table with the spreading factor of SF=2 respectively. For example, when the sequence selection information includes SF=2 and a starting index i=5, a subset of the basic sequence table may be expressed as {s50, s51}, or may be represented as {s52, s53}. According to FIG. 4 and FIG. 5, it can be seen that when the basic sequence table is the same, different subsets of the basic sequence table may be determined according to different manners in which different spreading factors are nested in the basic sequence table. In a specific implementation process, the length of a spreading sequence can also be changed according to different spreading factors. FIG. 6 shows an example of subsets of the basic sequence table with spreading factors of SF=4 and SF=2 respectively in the basic sequence table. As shown in FIG. 6, when the spreading factor is SF=4, a subset of the basic sequence table may be {1,−1,1,−1} when the basic sequence index i=1, for example. When the spreading factor is SF=2, a subset of the basic sequence table may be {1, −1} when the basic sequence index i=1, for example.

The foregoing describes various examples in which the UE determines a subset of the basic sequence table according to the basic sequence table and the sequence selection information. In an embodiment of the present disclosure, when transmission type or transmission scenario changes, or when the number of UEs changes, the base station may reconfigure the UE, and update the subset of the basic sequence table determined by the UE and its operation sequence. Specifically, when the user equipment being reconfigured, the base station may transmit updated sequence selection information, and cause the UE to determine an updated operation sequence according to the basic sequence table and the updated sequence selection information. Alternatively, the UE may first determine an updated subset of the basic sequence table according to the basic sequence table and the updated sequence selection information, and then determine the updated operation sequence therefrom. In addition, the base station can also indicate the updated sequence selection information through higher level signaling (for example, Radio Resource Control (RRC) signaling) or through, for example, Downlink Control Information (DCI). The sequence selection information may still include: one or more of a starting index for sequence selection, the number of groups for grouping the basic sequence table, a group index, the number of sequences in the subset of the basic sequence table and a spreading factor. Alternatively, the updated sequence selection information may be an updated value of one or more of the aforementioned parameters. For example, the updated sequence selection information may update the starting index for sequence selection i to i+offset by adding an offset value “offset”, and/or update the number of sequences in the subset of the basic sequence table m to m+offset. For another example, the updated sequence selection information may also modify the number of groups for grouping the basic sequence table K or the group index L to K+1 or L+2 respectively. The above manners for updating the sequence selection information are only examples. In practical applications, any manner for updating the sequence selection information can be used, which is not limited here.

In one example, when the UE determines an operation sequence for an operation from the subset of the basic sequence table (or the updated subset of the basic sequence table), it may arbitrarily select one of the sequences, as the operation sequence for the operation, in the subset determined according to the basic sequence table and the sequence selection information. In another example, in order to avoid resource conflicts with other UEs, the UE may also first receive operation sequence occupancy information transmitted by the base station and related to resources (as represented by operation sequences) occupied by the other UEs, and determine the operation sequence for the operation according to the operation sequence occupancy information. Alternatively, the operation sequence occupation information may be included in the sequence selection information to be transmitted together, or may be transmitted separately. That is, the operation sequence occupation information may be a part of the sequence selection information, or may be independent of the sequence selection information. Where, the base station can obtain operation sequences used by the other UEs through its received uplink data transmitted by the other UEs through a certain operation, and obtain the corresponding operation sequence occupation information to inform the UE. For example, when the subset of the basic sequence table determined by the UE is {s2, s3, s0, s1}, and the operation sequence occupancy information of the other UEs includes {s2}, this can make the UE select the operation sequence for the operation in {s3, s0, s1}.

FIG. 7 shows an example of information exchange between a UE, a base station and other UEs. As shown in FIG. 7, the base station may simultaneously transmit sequence selection information used to indicate the involvement of a certain operation to the UE and the other UEs. After receiving the sequence selection information, the UE and the other UEs may determine a subset of the basic sequence table according to the basic sequence table and the sequence selection information respectively, and further determine a respective operation sequence for the operation. In this process, the base station may transmit the sequence selection information within a specific time range before the operation is performed, so as to ensure that each UE can obtain the sequence selection information before performing the operation and further determine a corresponding operation sequence. After determining their respective operation sequences, the UE and the other UEs will perform corresponding operations and transmit uplink data. The sequence selection information may be transmitted periodically or aperiodically. In an example, the base station may transmit the sequence selection information together with other configuration information (for example, Modulation and Coding Scheme (MCS)) to save the signaling resources of the system. In another example, the base station may transmit the sequence selection information in a common search space by using GC-PDCCH (Physical Downlink Control Channel) or other DCI, so that each UE is able to detect the sequence selection information and without the need to separately instruct each UE.

FIG. 8 shows another example of information exchange between a UE, a base station and other UEs. As shown in FIG. 8, one or more UEs may first use an operation sequence corresponding to a certain available resource to operate and transmit uplink data to the base station, and then the base station may obtain corresponding operation sequence occupation information of the one or more UEs through its received uplink data related to the operation, and transmit sequence selection information and/or the operation sequence occupation information. After transmitting the operation sequence occupancy information, the base station can make other UEs avoid using the operation sequence which is already occupied to operate, thereby avoiding resource conflicts under Non-Orthogonal Multiple Access (NOMA), for example. Where, the operation sequence occupation information may be included in the sequence selection information for transmission, or may be transmitted separately. In this process, the base station may also transmit the sequence selection information and/or the operation sequence occupancy information within a specific time range before the operation is performed, so as to ensure that each UE can obtain required information before performing the operation and further determine a corresponding operation sequence. After determining their respective operation sequences, the UE and the other UEs will transmit uplink data respectively. The sequence selection information and/or operation sequence occupation information may be transmitted periodically or aperiodically. In an example, the base station may transmit the sequence selection information and/or the operation sequence occupation information together with other configuration information (for example, Modulation and Coding Scheme (MCS)) to save the signaling resources of the system. In another example, the base station may transmit the sequence selection information and/or the operation sequence occupation information in a common search space by using GC-PDCCH (Physical Downlink Control Channel) or other DCI, so that each UE is able to detect the sequence selection information and without the need to separately instruct each UE.

When the base station transmits the sequence selection information and/or the operation sequence occupation information through DCI, the transmission may be performed through an existing DCI format, or may be performed through a new DCI format. For example, the base station can use one or more existing DCIs for transmission: using DCI format 2_0, DCI format 2_1, DCI format 2_2, DCI format 2_3 in GC-PCDDH for transmission; using different Radio Network Tempory Identity (RNTI) scrambling manners in a common search space (DCI 0_0, DCI 0_1) for transmission, using reserved bits (for example, indexes 29-31 of table 1/3 in MCS, indexes 28-31 of other MCS tables) for transmission, or using a “uplink Sounding Reference Signal (SRS) resource indicator” field, a “precoding information and number of layers” field, a “antenna port” field and so on for transmission. For another example, the base station can also use a new 4-9 bits DCI format for transmission. In the foregoing various DCI transmission manners, the base station can use various value ranges to respectively indicate parameters such as the starting index of the demodulation reference signal and the number of groups, or the starting index of the multiple access signature sequence and the number of groups. For example, the starting index of the demodulation reference signal can be defined as 0-15, and the number of groups can be defined as 0-3; or the starting index of the multiple access signature sequence can be defined as 0-31, and the number of groups can be defined as 0-7. The above definition of the DCI formats and the value ranges of the related parameters is only an example. In practical applications, any DCI format and value manner can be used, and there is no limitation here.

The base station, which operates with the above-mentioned methods of the present disclosure, can make the user equipment determine a subset of a basic sequence table related to an operation to be performed by a user equipment according to the basic sequence table and sequence selection information related to the operation. Therefore, there is no need to separately provide a sequence table for each type of operation, and an operation sequence can be flexibly determined for the same or different operations of the user equipment, which improves the flexibility of sequence selection of the user equipment, reduces system overhead, and improves the performance of the wireless communication system. In addition, by restricting the subset of the basic sequence table corresponding to various operations of the user equipment, it is also possible to avoid resource conflicts under NOMA as much as possible, improving the effectiveness of information transmission.

A user equipment according to an embodiment of the present application is described below with reference to FIG. 10. The user equipment can perform the above-mentioned method performed by a user equipment. Since the operation of the user equipment is basically the same as the steps of the method described above, only a brief description is given here, and repeated descriptions of the same content are omitted.

As shown in FIG. 10, a user equipment 1000 includes an acquisition unit 1010, a receiving unit 1020, and a control unit 1030. It should be realized that FIG. 10 only shows components related to the embodiment of the present application, and other components are omitted. But this is only illustrative, and the user equipment 1000 may include other components as required.

The acquisition unit 1010 acquires a basic sequence table, and the basic sequence table includes at least two sequences.

In an embodiment, the basic sequence table may be stored in advance on both the UE side and the base station side respectively. For example, the basic sequence table can be set in advance through related standards and stored on both the UE side and the base station side. In another embodiment, the basic sequence table may also be exchanged between a base station and a UE through signaling. For example, the base station may inform the UE of the basic sequence table currently used by transmitting setting information of the related basic sequence table or selection information of multiple basic sequence tables through higher level (such as MAC layer) signaling or DCI, etc.

In one embodiment, the basic sequence table may respectively include basic sequence indexes and basic sequences corresponding to the basic sequence indexes. FIG. 3 shows a schematic diagram of a basic sequence table according to an embodiment of the present disclosure. As shown in FIG. 3, the basic sequence table may contain 8 basic sequences, which are s0-s8 respectively, with the basic sequence indexes of 0-7. The basic sequence table may be used by the UE to determine operation sequence(s) required for one or more types of operations. The representation of the basic sequence table, and the setting manner of one-to-one correspondence between the basic sequence indexes and the basic sequences in FIG. 3 are only examples. In practical applications, any setting manner of the basic sequence table can be used, and the number of the basic sequences contained therein is not limited.

The receiving unit 1020 receives sequence selection information related to an operation to be performed by the user equipment.

The receiving unit 1020 will receive the sequence selection information indicated by the base station, and the sequence selection information is related to the operation to be performed by the UE. The sequence selection information may cause the UE to select a subset of the basic sequence table related to the operation to be performed by the UE from the basic sequence table, and further determine an operation sequence for the operation therefrom. In one example, the base station may indicate the sequence selection information related to the operation to be performed by the UE through higher level signaling (such as Radio Resource Control (RRC) signaling); in another example, the base station may use, for example, Downlink Control Information (DCI) to indicate the sequence selection information related to the operation to be performed by the UE. In a specific implementation process, alternatively, the base station may indicate the type of the operation to be performed by the UE and the sequence selection information corresponding to the operation simultaneously, where the operation may be one or more. For example, the base station may indicate the type of the operation to be performed by the UE and the corresponding sequence selection information in an explicit manner (such as through one or more specific bits in the DCI); for another example, the base station may also indicate the type of the operation to be performed by the UE and the corresponding sequence selection information in an implicit manner (such as through specific positions in the DCI where the selection information is located), e.g., the first position in the DCI is used to indicate the operation type as MA signature addition and a corresponding MA sequence, and the second position in the DCI is used to indicate the operation type as DMRS transmission and a corresponding DMRS.

According to an embodiment of the present disclosure, the operation may include one or more of preamble transmission, multiple access signature addition, demodulation reference signal transmission, and spreading. According to another embodiment of the present disclosure, the sequence selection information may comprise: one or more of a starting index for sequence selection, the number of groups for grouping the basic sequence table, a group index, the number of sequences in the subset of the basic sequence table and a spreading factor.

The control unit 1030 determines an operation sequence for the operation according to the basic sequence table and the sequence selection information.

Where, the control unit 1030 may first determine the subset of the basic sequence table related to the operation according to the basic sequence table and the sequence selection information; and then, the control unit 1030 may determine the operation sequence for the operation from the subset of the basic sequence table. The subset of the basic sequence table may be the basic sequence table itself or a part of the basic sequence table.

In an example, the control unit 1030 may determine the subset of the basic sequence table related to the operation according to the basic sequence table, the number of the basic sequences M, the sequence selection information including a starting index for sequence selection i and the number of sequences in the subset of the basic sequence table m, and further determine an operation sequence in the subset. Since the UE has known the content of the basic sequence table, the value of the above-mentioned number of the basic sequences M can be directly obtained from the basic sequence table known by the UE. For example, when the operation is preamble transmission, a subset of the basic sequence table related to preamble transmission may be represented as: mod(i+j, M), where j=0, 1, . . . , m−1. Taking the basic sequence table shown in FIG. 3 as an example, when the number of the basic sequences M=8, the starting index for sequence selection i=6, and the number of sequences in the subset of the basic sequence table m=4, the subset of the basic sequence table for preamble sequence selection may be represented as {s6,s7,s0,s1}. The starting index for sequence selection i=6 in this example can also be understood as the index value, in the basic sequence table, of the starting sequence in the subset of the basic sequence table.

In another example, the control unit 1030 may determine the subset of the basic sequence table related to the operation according to the basic sequence table and the number of the basic sequences M, as well as the sequence selection information including a starting index for sequence selection i, the number of groups for grouping the basic sequence table K and the number of sequences in the subset of the basic sequence table m, and further determine an operation sequence in the subset. Likewise, the value of the above-mentioned number of the basic sequences M can be directly obtained from the basic sequence table known by the UE. Alternatively, the manner of grouping the basic sequence table may be a preset grouping manner, or the UE may be informed of a specific grouping manner by the base station, which is not limited here. In an example, when the operation is multiple access signature, a subset of the basic sequence table related to multiple access signature may be represented as: mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, and the number of sequences in the subset of the basic sequence table m=4, a subset of the basic sequence table for the selection of a multiple access signature sequence may be represented as {s2,s3,s0,s1}. The starting index for sequence selection i=6 in this example can also be understood as the starting value for calculating the subset of the basic sequence table. In this example, the subset of the basic sequence table can be obtained from one or more groups of the basic sequence table; of course, the subset of the basic sequence table can also be exactly the same as the one or more groups of the basic sequence table.

In another example, the control unit 1030 may determine the subset of the basic sequence table related to the operation according to the basic sequence table and the number of the basic sequences M, as well as the sequence selection information including a starting index for sequence selection i, the number of groups for grouping the basic sequence table K, a group index L and the number of sequences in the subset of the basic sequence table m, and further determine an operation sequence in the subset. Same as the foregoing, the value of the above-mentioned number of the basic sequences M can be directly obtained from the basic sequence table known by the UE. The manner of grouping the basic sequence table may be a preset grouping manner, or the UE may be informed of a specific grouping manner by the base station, which is not limited here. For example, when the operation is demodulation reference signal transmission, a subset of the basic sequence table related to the demodulation reference signal transmission may be represented as: L×M/K+mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, the group index L=1, and the number of sequences in the subset of the basic sequence table m=4, the subset of the basic sequence table for demodulation reference signal transmission may be represented as {s6,s7,s4,s5}. Likewise, in this example, the subset of the basic sequence table can be obtained from one or more groups of the basic sequence table; of course, the subset of the basic sequence table can also be exactly the same as the one or more groups of the basic sequence table.

In another example, the control unit 1030 may determine a subset of the basic sequence table related to spreading according to the basic sequence table and the sequence selection information including a spreading factor (SF), for indicating an spreading sequence used when spreading. FIG. 4 shows an example of subsets of the basic sequence table with a spreading factor of SF=4 in the basic sequence table. The table shown in FIG. 4 is the basic sequence table, and the part within the block is the subsets of the basic sequence table with the spreading factor of SF=4. For example, when the sequence selection information includes SF=4 and a starting index i=2, a subset of the basic sequence table may be represented as {s20,s21,s22,s23}. FIG. 5 shows an example of subsets of the basic sequence table with a spreading factor of SF=2 in the basic sequence table. The table shown in FIG. 5 is the basic sequence table, and the parts within the two blocks are the subsets of the basic sequence table with the spreading factor of SF=2 respectively. For example, when the sequence selection information includes SF=2 and a starting index i=5, a subset of the basic sequence table may be expressed as {s50, s51}, or may be represented as {s52, s53}. According to FIG. 4 and FIG. 5, it can be seen that when the basic sequence table is the same, different subsets of the basic sequence table may be determined according to different manners in which different spreading factors are nested in the basic sequence table. In a specific implementation process, the length of a spreading sequence can also be changed according to different spreading factors. FIG. 6 shows an example of subsets of the basic sequence table with spreading factors of SF=4 and SF=2 respectively in the basic sequence table. As shown in FIG. 6, when the spreading factor is SF=4, a subset of the basic sequence table may be {1,−1,1,−1} when the basic sequence index i=1, for example. When the spreading factor is SF=2, a subset of the basic sequence table may be {1, −1} when the basic sequence index i=1, for example.

The foregoing describes various examples in which the control unit 1030 determines a subset of the basic sequence table according to the basic sequence table and the sequence selection information. In an embodiment of the present disclosure, when transmission type or transmission scenario changes, or when the number of UEs changes, the UE can be reconfigured, and the subset of the basic sequence table determined by the UE and its operation sequence may be updated. Specifically, when the user equipment being reconfigured, the receiving unit 1020 may receive updated sequence selection information transmitted by the base station, and the control unit 1030 may determine an updated operation sequence according to the basic sequence table and the updated sequence selection information. Alternatively, the control unit 1030 may first determine an updated subset of the basic sequence table according to the basic sequence table and the updated sequence selection information, and then determine the updated operation sequence therefrom. In addition, the base station can also indicate the updated sequence selection information through higher level signaling (for example, Radio Resource Control (RRC) signaling) or through, for example, Downlink Control Information (DCI). The sequence selection information may still include: one or more of a starting index for sequence selection, the number of groups for grouping the basic sequence table, a group index, the number of sequences in the subset of the basic sequence table and a spreading factor. Alternatively, the updated sequence selection information may be an updated value of one or more of the aforementioned parameters. For example, the updated sequence selection information may update the starting index for sequence selection i to i+offset by adding an offset value “offset”, and/or update the number of sequences in the subset of the basic sequence table m to m+offset. For another example, the updated sequence selection information may also modify the number of groups for grouping the basic sequence table K or the group index L to K+1 or L+2 respectively. The above manners for updating the sequence selection information are only examples. In practical applications, any manner for updating the sequence selection information can be used, which is not limited here.

In one example, when the control unit 1030 determines an operation sequence for an operation from the subset of the basic sequence table (or the updated subset of the basic sequence table), it may arbitrarily select one of the sequences, as the operation sequence for the operation, in the subset determined according to the basic sequence table and the sequence selection information. In another example, in order to avoid resource conflicts with other UEs, the UE may also first use the receiving unit 1020 to receive operation sequence occupancy information transmitted by the base station and related to resources (as represented by operation sequences) occupied by the other UEs, so that the control unit 1030 determines the operation sequence for the operation according to the operation sequence occupancy information. Alternatively, the operation sequence occupation information may be included in the sequence selection information to be transmitted together, or may be transmitted separately. That is, the operation sequence occupation information may be a part of the sequence selection information, or may be independent of the sequence selection information. Where, the base station can obtain operation sequences used by the other UEs through its received uplink data transmitted by the other UEs through a certain operation, and obtain the corresponding operation sequence occupation information to inform the UE. For example, when the subset of the basic sequence table determined by the UE is {s2, s3, s0, s1}, and the operation sequence occupancy information of the other UEs includes {s2}, this can make the UE select the operation sequence for the operation in {s3, s0, s1}.

FIG. 7 shows an example of information exchange between a UE, a base station and other UEs. As shown in FIG. 7, the base station may simultaneously transmit sequence selection information used to indicate the involvement of a certain operation to the UE and the other UEs. After receiving the sequence selection information, the UE and the other UEs may determine a subset of the basic sequence table according to the basic sequence table and the sequence selection information respectively, and further determine a respective operation sequence for the operation. In this process, the base station may transmit the sequence selection information within a specific time range before the operation is performed, so as to ensure that each UE can obtain the sequence selection information before performing the operation and further determine a corresponding operation sequence. After determining their respective operation sequences, the UE and the other UEs will perform corresponding operations and transmit uplink data. The sequence selection information may be transmitted periodically or aperiodically. In an example, the base station may transmit the sequence selection information together with other configuration information (for example, Modulation and Coding Scheme (MCS)) to save the signaling resources of the system. In another example, the base station may transmit the sequence selection information in a common search space by using GC-PDCCH (Physical Downlink Control Channel) or other DCI, so that each UE is able to detect the sequence selection information and without the need to separately instruct each UE.

FIG. 8 shows another example of information exchange between a UE, a base station and other UEs. As shown in FIG. 8, one or more UEs may first use an operation sequence corresponding to a certain available resource to operate and transmit uplink data to the base station, and then the base station may obtain corresponding operation sequence occupation information of the one or more UEs through its received uplink data related to the operation, and transmit sequence selection information and/or the operation sequence occupation information. After transmitting the operation sequence occupancy information, the base station can make other UEs avoid using the operation sequence which is already occupied to operate, thereby avoiding resource conflicts under Non-Orthogonal Multiple Access (NOMA), for example. Where, the operation sequence occupation information may be included in the sequence selection information for transmission, or may be transmitted separately. In this process, the base station may also transmit the sequence selection information and/or the operation sequence occupancy information within a specific time range before the operation is performed, so as to ensure that each UE can obtain required information before performing the operation and further determine a corresponding operation sequence. After determining their respective operation sequences, the UE and the other UEs will transmit uplink data respectively. The sequence selection information and/or operation sequence occupation information may be transmitted periodically or aperiodically. In an example, the base station may transmit the sequence selection information and/or the operation sequence occupation information together with other configuration information (for example, Modulation and Coding Scheme (MCS)) to save the signaling resources of the system. In another example, the base station may transmit the sequence selection information and/or the operation sequence occupation information in a common search space by using GC-PDCCH (Physical Downlink Control Channel) or other DCI, so that each UE is able to detect the sequence selection information and without the need to separately instruct each UE.

When the base station transmits the sequence selection information and/or the operation sequence occupation information through DCI, the transmission may be performed through an existing DCI format, or may be performed through a new DCI format. For example, the base station can use one or more existing DCIs for transmission: using DCI format 2_0, DCI format 2_1, DCI format 2_2, DCI format 2_3 in GC-PCDDH for transmission; using different Radio Network Tempory Identity (RNTI) scrambling manners in a common search space (DCI 0_0, DCI 0_1) for transmission, using reserved bits (for example, indexes 29-31 of table 1/3 in MCS, indexes 28-31 of other MCS tables) for transmission, or using a “uplink Sounding Reference Signal (SRS) resource indicator” field, a “precoding information and number of layers” field, a “antenna port” field and so on for transmission. For another example, the base station can also use a new 4-9 bits DCI format for transmission. In the foregoing various DCI transmission manners, the base station can use various value ranges to respectively indicate parameters such as the starting index of the demodulation reference signal and the number of groups, or the starting index of the multiple access signature sequence and the number of groups. For example, the starting index of the demodulation reference signal can be defined as 0-15, and the number of groups can be defined as 0-3; or the starting index of the multiple access signature sequence can be defined as 0-31, and the number of groups can be defined as 0-7. The above definition of the DCI formats and the value ranges of the related parameters is only an example. In practical applications, any DCI format and value manner can be used, and there is no limitation here.

With the above-mentioned user equipment of the present disclosure, a subset of a basic sequence table related to an operation to be performed by the user equipment can be determined according to the basic sequence table and sequence selection information indicated by the base station and related to the operation. Therefore, there is no need to separately set a sequence table for each type of operation, and an operation sequence can be flexibly determined for the same or different operations of the user equipment, which improves the flexibility of sequence selection of the user equipment, reduces system overhead, and improves the performance of the wireless communication system. In addition, by restricting the subset of the basic sequence table corresponding to various operations of the user equipment, it is also possible to avoid resource conflicts under NOMA as much as possible, improving the effectiveness of information transmission.

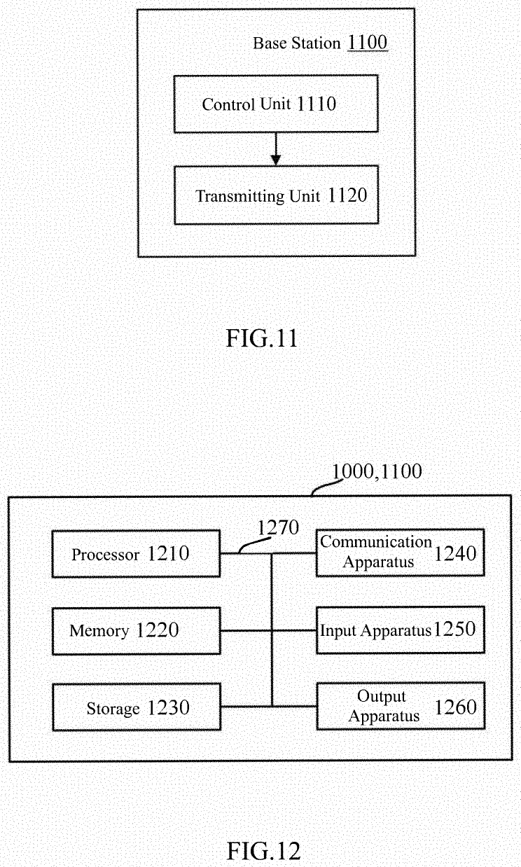

A base station according to an embodiment of the present application will be described below with reference to FIG. 11. The base station can performed the above-mentioned method performed by a base station. Since the operation of the base station is basically the same as the steps of the method described above, only a brief description is given here, and repeated descriptions of the same content are omitted.

As shown in FIG. 11, the base station 1100 includes a control unit 1110 and a transmitting unit 1120. It needs to be realized that FIG. 11 only shows components related to the embodiment of the present application, and other components are omitted. But this is only illustrative, and the base station 1100 may include other components as required.

The control unit 1110 determines sequence selection information related to an operation to be performed by a user equipment.

The sequence selection information is used by a UE to determine an operation sequence for the operation from a basic sequence table. Specifically, the UE may first determine a subset of the basic sequence table related to the operation according to the basic sequence table and the sequence selection information; and then, the UE may determine the operation sequence for the operation from the subset of the basic sequence table.

In an embodiment, the basic sequence table may be stored in advance on both the UE side and the base station side respectively. For example, the basic sequence table can be set in advance through related standards and stored on both the UE side and the base station side. In another embodiment, the basic sequence table may also be exchanged between a base station and a UE through signaling. For example, the base station may inform the UE of the basic sequence table currently used by transmitting setting information of the related basic sequence table or selection information of multiple basic sequence tables through higher level (such as MAC layer) signaling or DCI, etc.

In one embodiment, the basic sequence table may respectively include basic sequence indexes and basic sequences corresponding to the basic sequence indexes. FIG. 3 shows a schematic diagram of a basic sequence table according to an embodiment of the present disclosure. As shown in FIG. 3, the basic sequence table may contain 8 basic sequences, which are s0-s8 respectively, with the basic sequence indexes of 0-7. The basic sequence table may be used by the UE to determine operation sequence(s) required for one or more types of operations. The representation of the basic sequence table, and the setting manner of one-to-one correspondence between the basic sequence indexes and the basic sequences in FIG. 3 are only examples. In practical applications, any setting manner of the basic sequence table can be used, and the number of the basic sequences contained therein is not limited.

According to an embodiment of the present disclosure, the operation to be performed by the user equipment may include one or more of preamble transmission, multiple access signature addition, demodulation reference signal transmission, and spreading. According to another embodiment of the present disclosure, the sequence selection information may comprise: one or more of a starting index for sequence selection, the number of groups for grouping the basic sequence table, a group index, the number of sequences in the subset of the basic sequence table and a spreading factor.

The transmitting unit 1120 transmits the sequence selection information, so that the user equipment determines an operation sequence for the operation according to the basic sequence table including at least two sequences and the sequence selection information.

In one example, the transmitting unit 1120 may indicate the sequence selection information related to the operation to be performed by the UE through higher level signaling (such as Radio Resource Control (RRC) signaling); in another example, the transmitting unit 1120 may use, for example, Downlink Control Information (DCI) to indicate the sequence selection information related to the operation to be performed by the UE. In a specific implementation process, alternatively, the transmitting unit 1120 may indicate the type of the operation to be performed by the UE and the sequence selection information corresponding to the operation simultaneously, where the operation may be one or more. For example, the transmitting unit 1120 may indicate the type of the operation to be performed by the UE and the corresponding sequence selection information in an explicit manner (such as through one or more specific bits in the DCI); for another example, the transmitting unit 1120 may also indicate the type of the operation to be performed by the UE and the corresponding sequence selection information in an implicit manner (such as through specific positions in the DCI where the selection information is located), e.g., the first position in the DCI is used to indicate the operation type as MA signature addition and a corresponding MA sequence, and the second position in the DCI is used to indicate the operation type as DMRS transmission and a corresponding DMRS.

After receiving the sequence selection information transmitted by the base station, as described in the above, the UE may first determine the subset of the basic sequence table related to the operation according to the basic sequence table and the sequence selection information; and then, the UE may determine the operation sequence for the operation from the subset of the basic sequence table. The subset of the basic sequence table may be the basic sequence table itself or a part of the basic sequence table.

In an example, the UE may determine the subset of the basic sequence table related to the operation according to the basic sequence table, the number of the basic sequences M, the sequence selection information including a starting index for sequence selection i and the number of sequences in the subset of the basic sequence table m, and further determine an operation sequence in the subset. Since the UE has known the content of the basic sequence table, the value of the above-mentioned number of the basic sequences M can be directly obtained from the basic sequence table known by the UE. For example, when the operation is preamble transmission, a subset of the basic sequence table related to preamble transmission may be represented as: mod(i+j, M), where j=0, 1, . . . , m−1. Taking the basic sequence table shown in FIG. 3 as an example, when the number of the basic sequences M=8, the starting index for sequence selection i=6, and the number of sequences in the subset of the basic sequence table m=4, the subset of the basic sequence table for preamble sequence selection may be represented as {s6,s7,s0,s1}. The starting index for sequence selection i=6 in this example can also be understood as the index value, in the basic sequence table, of the starting sequence in the subset of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K and the number of sequences in the subset of the basic sequence table m, and further determine an operation sequence in the subset. Likewise, the value of the above-mentioned number of the basic sequences M can be directly obtained from the basic sequence table known by the UE. Alternatively, the manner of grouping the basic sequence table may be a preset grouping manner, or the UE may be informed of a specific grouping manner by the base station, which is not limited here. In an example, when the operation is multiple access signature, a subset of the basic sequence table related to multiple access signature may be represented as: mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, and the number of sequences in the subset of the basic sequence table m=4, a subset of the basic sequence table for the selection of a multiple access signature sequence may be represented as {s2,s3,s0,s1}. The starting index for sequence selection i=6 in this example can also be understood as the starting value for calculating the subset of the basic sequence table. In this example, the subset of the basic sequence table can be obtained from one or more groups of the basic sequence table; of course, the subset of the basic sequence table can also be exactly the same as the one or more groups of the basic sequence table.

In another example, the UE may determine the subset of the basic sequence table related to the operation according to the basic sequence table and the number of the basic sequences M, as well as the sequence selection information including a starting index for sequence selection i, the number of groups for grouping the basic sequence table K, a group index L and the number of sequences in the subset of the basic sequence table m, and further determine an operation sequence in the subset. Same as the foregoing, the value of the above-mentioned number of the basic sequences M can be directly obtained from the basic sequence table known by the UE. The manner of grouping the basic sequence table may be a preset grouping manner, or the UE may be informed of a specific grouping manner by the base station, which is not limited here. For example, when the operation is demodulation reference signal transmission, a subset of the basic sequence table related to the demodulation reference signal transmission may be represented as: L×M/K+mod(i+j, M/K), where j=0, 1, . . . , m−1. In the example of the basic sequence table shown in FIG. 3, when the number of the basic sequences M=8, the starting index for sequence selection i=6, the number of groups for grouping the basic sequence table K=2, the group index L=1, and the number of sequences in the subset of the basic sequence table m=4, the subset of the basic sequence table for the demodulation reference signal transmission may be represented as {s6,s7,s4,s5}. Likewise, in this example, the subset of the basic sequence table can be obtained from one or more groups of the basic sequence table; of course, the subset of the basic sequence table can also be exactly the same as the one or more groups of the basic sequence table.

In another example, the UE may determine a subset of the basic sequence table related to spreading according to the basic sequence table and the sequence selection information including a spreading factor (SF), for indicating an spreading sequence used when spreading. FIG. 4 shows an example of subsets of the basic sequence table with a spreading factor of SF=4 in the basic sequence table. The table shown in FIG. 4 is the basic sequence table, and the part within the block is the subsets of the basic sequence table with the spreading factor of SF=4. For example, when the sequence selection information includes SF=4 and a starting index i=2, a subset of the basic sequence table may be represented as {s20,s21,s22,s23}. FIG. 5 shows an example of subsets of the basic sequence table with a spreading factor of SF=2 in the basic sequence table. The table shown in FIG. 5 is the basic sequence table, and the parts within the two blocks are the subsets of the basic sequence table with the spreading factor of SF=2 respectively. For example, when the sequence selection information includes SF=2 and a starting index i=5, a subset of the basic sequence table may be expressed as {s50, s51}, or may be represented as {s52, s53}. According to FIG. 4 and FIG. 5, it can be seen that when the basic sequence table is the same, different subsets of the basic sequence table may be determined according to different manners in which different spreading factors are nested in the basic sequence table. In a specific implementation process, the length of a spreading sequence can also be changed according to different spreading factors. FIG. 6 shows an example of subsets of the basic sequence table with spreading factors of SF=4 and SF=2 respectively in the basic sequence table. As shown in FIG. 6, when the spreading factor is SF=4, a subset of the basic sequence table may be {1,−1,1,−1} when the basic sequence index i=1, for example. When the spreading factor is SF=2, a subset of the basic sequence table may be {1, −1} when the basic sequence index i=1, for example.

The foregoing describes various examples in which the UE determines a subset of the basic sequence table according to the basic sequence table and the sequence selection information. In an embodiment of the present disclosure, when transmission type or transmission scenario changes, or when the number of UEs changes, the base station may reconfigure the UE, and update the subset of the basic sequence table determined by the UE and its operation sequence. Specifically, when the user equipment being reconfigured, the transmitting unit 1120 may transmit updated sequence selection information, and cause the UE to determine an updated operation sequence according to the basic sequence table and the updated sequence selection information. Alternatively, the UE may first determine an updated subset of the basic sequence table according to the basic sequence table and the updated sequence selection information, and then determine the updated operation sequence therefrom. In addition, the transmitting unit 1120 can also indicate the updated sequence selection information through higher level signaling (for example, Radio Resource Control (RRC) signaling) or through, for example, Downlink Control Information (DCI). The sequence selection information may still include: one or more of a starting index for sequence selection, the number of groups for grouping the basic sequence table, a group index, the number of sequences in the subset of the basic sequence table and a spreading factor. Alternatively, the updated sequence selection information may be an updated value of one or more of the aforementioned parameters. For example, the updated sequence selection information may update the starting index for sequence selection i to i+offset by adding an offset value “offset”, and/or update the number of sequences in the subset of the basic sequence table m to m+offset. For another example, the updated sequence selection information may also modify the number of groups for grouping the basic sequence table K or the group index L to K+1 or L+2 respectively. The above manners for updating the sequence selection information are only examples. In practical applications, any manner for updating the sequence selection information can be used, which is not limited here.

In one example, when the UE determines an operation sequence for an operation from the subset of the basic sequence table (or the updated subset of the basic sequence table), it may arbitrarily select one of the sequences, as the operation sequence for the operation, in the subset determined according to the basic sequence table and the sequence selection information. In another example, in order to avoid resource conflicts with other UEs, the UE may also first receive operation sequence occupancy information transmitted by the transmitting unit 1120 of the base station and related to resources (as represented by operation sequences) occupied by the other UEs, and determine the operation sequence for the operation according to the operation sequence occupancy information. Alternatively, the operation sequence occupation information may be included in the sequence selection information to be transmitted together, or may be transmitted separately. That is, the operation sequence occupation information may be a part of the sequence selection information, or may be independent of the sequence selection information. Where, the base station can obtain operation sequences used by the other UEs through its received uplink data transmitted by the other UEs through a certain operation, and obtain the corresponding operation sequence occupation information to inform the UE. For example, when the subset of the basic sequence table determined by the UE is {s2, s3, s0, s1}, and the operation sequence occupancy information of the other UEs includes {s2}, this can make the UE select the operation sequence for the operation in {s3, s0, s1}.

FIG. 7 shows an example of information exchange between a UE, a base station and other UEs. As shown in FIG. 7, the base station may simultaneously transmit sequence selection information used to indicate the involvement of a certain operation to the UE and the other UEs. After receiving the sequence selection information, the UE and the other UEs may determine a subset of the basic sequence table according to the basic sequence table and the sequence selection information respectively, and further determine a respective operation sequence for the operation. In this process, the base station may transmit the sequence selection information within a specific time range before the operation is performed, so as to ensure that each UE can obtain the sequence selection information before performing the operation and further determine a corresponding operation sequence. After determining their respective operation sequences, the UE and the other UEs will perform corresponding operations and transmit uplink data. The sequence selection information may be transmitted periodically or aperiodically. In an example, the base station may transmit the sequence selection information together with other configuration information (for example, Modulation and Coding Scheme (MCS)) to save the signaling resources of the system. In another example, the base station may transmit the sequence selection information in a common search space by using GC-PDCCH (Physical Downlink Control Channel) or other DCI, so that each UE is able to detect the sequence selection information and without the need to separately instruct each UE.

FIG. 8 shows another example of information exchange between a UE, a base station and other UEs. As shown in FIG. 8, one or more UEs may first use an operation sequence corresponding to a certain available resource to operate and transmit uplink data to the base station, and then the base station may obtain corresponding operation sequence occupation information of the one or more UEs through its received uplink data related to the operation, and transmit sequence selection information and/or the operation sequence occupation information. After transmitting the operation sequence occupancy information, the base station can make other UEs avoid using the operation sequence which is already occupied to operate, thereby avoiding resource conflicts under Non-Orthogonal Multiple Access (NOMA), for example. Where, the operation sequence occupation information may be included in the sequence selection information for transmission, or may be transmitted separately. In this process, the base station may also transmit the sequence selection information and/or the operation sequence occupancy information within a specific time range before the operation is performed, so as to ensure that each UE can obtain required information before performing the operation and further determine a corresponding operation sequence. After determining their respective operation sequences, the UE and the other UEs will transmit uplink data respectively. The sequence selection information and/or operation sequence occupation information may be transmitted periodically or aperiodically. In an example, the base station may transmit the sequence selection information and/or the operation sequence occupation information together with other configuration information (for example, Modulation and Coding Scheme (MCS)) to save the signaling resources of the system. In another example, the base station may transmit the sequence selection information and/or the operation sequence occupation information in a common search space by using GC-PDCCH (Physical Downlink Control Channel) or other DCI, so that each UE is able to detect the sequence selection information and without the need to separately instruct each UE.

When the transmitting unit 1120 of the base station transmits the sequence selection information and/or the operation sequence occupation information through DCI, the transmission may be performed through an existing DCI format, or may be performed through a new DCI format. For example, the transmitting unit 1120 can use one or more existing DCIs for transmission: using DCI format 2_0, DCI format 2_1, DCI format 2_2, DCI format 2_3 in GC-PCDDH for transmission; using different Radio Network Tempory Identity (RNTI) scrambling manners in a common search space (DCI 0_0, DCI 0_1) for transmission, using reserved bits (for example, indexes 29-31 of table 1/3 in MCS, indexes 28-31 of other MCS tables) for transmission, or using a “uplink Sounding Reference Signal (SRS) resource indicator” field, a “precoding information and number of layers” field, a “antenna port” field and so on for transmission. For another example, the transmitting unit 1120 can also use a new 4-9 bits DCI format for transmission. In the foregoing various DCI transmission manners, the transmitting unit 1120 can use various value ranges to respectively indicate parameters such as the starting index of the demodulation reference signal and the number of groups, or the starting index of the multiple access signature sequence and the number of groups. For example, the starting index of the demodulation reference signal can be defined as 0-15, and the number of groups can be defined as 0-3; or the starting index of the multiple access signature sequence can be defined as 0-31, and the number of groups can be defined as 0-7. The above definition of the DCI formats and the value ranges of the related parameters is only an example. In practical applications, any DCI format and value manner can be used, and there is no limitation here.

With the above-mentioned base station of the present disclosure, a user equipment can be made to determine a subset of a basic sequence table related to an operation to be performed by a user equipment according to the basic sequence table and sequence selection information related to the operation. Therefore, there is no need to separately provide a sequence table for each type of operation, and an operation sequence can be flexibly determined for the same or different operations of the user equipment, which improves the flexibility of sequence selection of the user equipment, reduces system overhead, and improves the performance of the wireless communication system. In addition, by restricting the subset of the basic sequence table corresponding to various operations of the user equipment, it is also possible to avoid resource conflicts under NOMA as much as possible, improving the effectiveness of information transmission.

<Hardware Structure>

The receiving device, the receiving device and the like in one embodiment of the present disclosure may function as a computer that executes the processes of the wireless communication method of the present disclosure. FIG. 12 is a diagram illustrating an example of a hardware structure of a user equipment and a base station involved in one embodiment of the present disclosure. The user equipment 1000 and the base station 1100 described above may be constituted as a computer apparatus that physically comprises a processor 1210, a memory 1220, a storage 1230, a communication apparatus 1240, an input apparatus 1250, an output apparatus 1260, a bus 1270 and the like

In addition, in the following description, terms such as “apparatus” may be replaced with circuits, devices, units, and the like. The hardware structure of the user equipment 1000 and the base station 1100 may include one or more of the respective apparatuses shown in the figure, or may not include a part of the apparatuses.

For example, only one processor 1210 is illustrated, but there may be a plurality of processors. Furthermore, processes may be performed by one processor, or processes may be performed by more than one processor simultaneously, sequentially, or by other methods. In addition, the processor 1210 may be installed by more than one chip.

Respective functions of the user equipment 1000 and the base station 1100 may be implemented, for example, by reading specified software (program) onto hardware such as the processor 1210 and the memory 1220, so that the processor 1210 performs computations, controls communication performed by the communication apparatus 1240, and controls reading and/or writing of data in the memory 1220 and the storage 1230.

The processor 1210, for example, operates an operating system to control the entire computer. The processor 1210 may be constituted by a Central Processing Unit (CPU), which includes interfaces with peripheral apparatuses, a control apparatus, a computing apparatus, a register and the like.

In addition, the processor 1210 reads programs (program codes), software modules and data from the storage 1230 and/or the communication apparatus 1240 to the memory 1220, and execute various processes according to them. As for the program, a program causing computers to execute at least a part of the operations described in the above embodiments may be employed.

The memory 1220 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 1220 may also be referred to as a register, a cache, a main memory (a main storage apparatus) and the like. The memory 1220 may store executable programs (program codes), software modules and the like for implementing the method involved in one embodiment of the present disclosure.

The storage 1230 is a computer-readable recording medium, and may be constituted, for example, by at least one of a flexible disk, a floppy disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 1230 may also be referred to as an auxiliary storage apparatus.

The communication apparatus 1240 is a hardware (transceiver device) performing communication between computers via a wired and/or wireless network, and is also referred to as a network device, a network controller, a network card, a communication module and the like, for example. The communication apparatus 1240 may include a high-frequency switch, a duplexer, a filter, a frequency synthesizer and the like to implement, for example, Frequency Division Duplex (FDD) and/or Time Division Duplex (TDD).

The input apparatus 1250 is an input device (e.g., a keyboard, a mouse, a microphone, a switch, a button, a sensor and the like) that receives input from the outside. The output apparatus 1260 is an output device (e.g., a display, a speaker, a Light Emitting Diode (LED) light and the like) that performs outputting to the outside. In addition, the input apparatus 1250 and the output apparatus 1260 may also be an integrated structure (e.g., a touch screen).

Furthermore, the respective apparatuses such as the processor 1210 and the memory 1220 are connected by the bus 1270 that communicates information. The bus 1270 may be constituted by a single bus or by different buses between the apparatuses.

Furthermore, the user equipment 1000 and the base station 1100 may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 1210 may be installed by at least one of the hardware.

(Variations)

In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a “pilot”, a “pilot signal” and so on, depending on the standard applied. Furthermore, a component carrier (CC) may also be referred to as a cell, a frequency carrier, a carrier frequency, and the like.

In addition, a radio frame may be composed of one or more periods (frames) in the time domain Each of the one or more periods (frames) constituting the radio frame may also be referred to as a subframe. Furthermore, a subframe may be composed of one or more slots in the time domain. The subframe may be a fixed time length (for example, 1 ms) that is independent of the numerology.

Furthermore, a slot may be composed of one or more symbols (Orthogonal Frequency Division Multiplexing (OFDM) symbols, Single Carrier Frequency Division Multiple Access (SC-FDMA) symbols, etc.) in the time domain. In addition, the slot can also be a time unit based on the numerology. In addition, the slot may also include a plurality of microslots. Each microslot can be composed of one or more symbols in the time domain. In addition, the microslot may also be referred to as a sub slot.

A radio frame, a subframe, a slot, a microslot and a symbol all represent a time unit during signal transmission. A radio frame, a subframe, a slot, a microslot and a symbol may also use other names that correspond to them, respectively. For example, one subframe may be referred to as a “transmission time interval (TTI)”, a plurality of consecutive subframes may also be referred to as a “TTI”, and one slot or one microslot may also be referred to as a “TTI.” That is, a subframe and/or a TTI may be a subframe (1 ms) in the existing LTE, may be a period of time shorter than 1 ms (e.g., 1 to 13 symbols), or may be a period of time longer than 1 ms. In addition, a unit indicating a TTI may also be referred to as a slot, a microslot and the like instead of a subframe.

Herein, a TTI refers to the minimum time unit of scheduling in wireless communication, for example. For example, in LTE systems, a wireless base station performs scheduling for respective user terminals that allocates radio resources (such as frequency bandwidths and transmission power that can be used in respective user terminals) in units of TTI. In addition, the definition of the TTI is not limited thereto.

A TTI may be a transmission time unit of channel-coded data packets (transport blocks), code blocks, and/or codewords, or may be a processing unit of scheduling, link adaptation and so on. In addition, when a TTI is given, a time interval (e.g., the number of symbols) mapped to transport blocks, code blocks, and/or codewords actually may also be shorter than the TTI.

In addition, when one slot or one microslot is referred to as a TTI, more than one TTI (that is, more than one slot or more than one microslot) may also become the minimum time unit for scheduling. In addition, the number of slots (the number of microslots) constituting the minimum time unit for the scheduling can be controlled.

A TTI with a time length of 1 ms may also be referred to as a regular TTI (TTI in LTE Rel. 8-12), a standard TTI, a long TTI, a regular subframe, a standard subframe, or a long subframe, etc. A TTI shorter than the regular TTI may also be referred to as a compressed TTI, a short TTI, a partial or fractional TTI, a compressed subframe, a short subframe, a microslot, or a sub slot, etc.

In addition, a long TTI (such as a regular TTI, subframe, etc.) can also be replaced with a TTI with a time length exceeding 1 ms, and a short TTI (such as a compressed TTI, etc.) can also be replaced with a TTI with a length shorter than that of a long TTI and with a TTI length longer than 1 ms.

A resource block (RB) is a resource allocation unit in the time domain and the frequency domain, and may include one or more consecutive subcarriers in the frequency domain. Also, an RB may include one or more symbols in the time domain, and may be one slot, one microslot, one subframe or one TTI duration. One TTI and one subframe may be composed of one or more resource blocks, respectively. In addition, one or more RBs may also be referred to as “physical resource blocks (PRBs (Physical RBs))”, “Sub-Carrier Groups (SCGs)”, “Resource Element Groups (REGs)”, “PRG pairs”, “RB pairs” and so on.

In addition, a resource block may also be composed of one or more Resource Elements (RE). For example, one RE may be a radio resource area of one subcarrier and one symbol.

In addition, structures of the radio frames, subframes, slots, microslots and symbols, etc. described above are simply examples. For example, configurations such as the number of subframes included in a radio frame, the number of slots of each subframe or radio frame, the number or microslots included in a slot, the number of symbols and RBs included in a slot or microslot, the number of subcarriers included in an RB, the number of symbols in a TTI, the symbol duration and the cyclic prefix (CP) duration may be variously altered.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. Information, signals and the like that are output may be deleted. Information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as “RRC messages”, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or referred to as by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. The base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Also, both the user equipment 1000 and the base station 1100 in this specification may be replaced with a wireless base station or a user terminal.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (New Radio Access Technology), NR (New Radio), NX (New radio access), FX (Future generation radio access), GSM (Global System for Mobile communications), CDMA 2000, UMB (Ultra Mobile Broadband), IEEE 1220.11 (Wi-Fi®), IEEE 1220.16 (WiMAX®), IEEE 1220.20, UWB (Ultra-Wide Band), Bluetooth and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described in detail above, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A user equipment, comprising:
an acquisition unit configured to acquire a basic sequence table, the basic sequence table includes at least two sequences;
a receiving unit configured to receive sequence selection information related to an operation to be performed by the user equipment;
a control unit configured to determine an operation sequence for the operation according to the basic sequence table and the sequence selection information.

2. The user equipment of claim 1, wherein,
the control unit determines a subset of the basic sequence table related to the operation according to the basic sequence table and the sequence selection information;
determining the operation sequence for the operation from the subset of the basic sequence table.

3. The user equipment of claim 1, wherein,
the operation includes one or more of preamble transmission, multiple access signature addition, demodulation reference signal transmission and spreading.

4. The user equipment of claim 1, wherein the sequence selection information comprises:
one or more of a starting index for sequence selection, a number of groups for grouping the basic sequence table, a group index, a number of sequences in the subset of the basic sequence table and a spreading factor.

5. The user equipment of claim 1, wherein,
the receiving unit receives updated sequence selection information when the user equipment being reconfigured;
the control unit determines an updated operation sequence according to the basic sequence table and the updated sequence selection information.

6. The user equipment of claim 1, wherein,
the receiving unit receives operation sequence occupation information transmitted by a base station;
the control unit determines the operation sequence for the operation according to the operation sequence occupation information.

7. A base station, comprising:
a control unit configured to determine sequence selection information related to an operation to be performed by a user equipment;
a transmitting unit configured to transmit the sequence selection information, so that the user equipment determines an operation sequence for the operation according to the basic sequence table and the sequence selection information.

8. The base station of claim 7, wherein,
the operation includes one or more of preamble transmission, multiple access signature addition, demodulation reference signal transmission and spreading.

9. The base station of claim 7, wherein the sequence selection information comprises:
one or more of a starting index for sequence selection, a number of groups for grouping the basic sequence table, a group index, a number of sequences in the subset of the basic sequence table and a spreading factor.

10. The base station of claim 7, wherein,
the transmitting unit transmits updated sequence selection information when the user equipment being reconfigured, so that the user equipment determines an updated operation sequence according to the basic sequence table and the updated sequence selection information.

11. The base station of claim 7, wherein,
the base station further comprises an acquisition unit configured to acquire the operation sequence used by the user equipment for the operation;
the transmitting unit transmits operation sequence occupation information according to the operation sequence, so that other user equipment determines its own operation sequence for the operation according to the operation sequence occupation information.

12. A method performed by a user equipment, the method comprising:
acquiring a basic sequence table, the basic sequence table includes at least two sequences;
receiving sequence selection information related to an operation to be performed by the user equipment;
determining an operation sequence for the operation according to the basic sequence table and the sequence selection information.

13. (canceled)
